(19) United States
(12) Patent Application Publication
(10) Pub. No.: US 2008/0244982 A1
(43) Pub. Date: Oct. 9, 2008

(54) CABLE GUIDE

(75) Inventor: Chiharu AZUMA, Takarazuka-shi (JP)

Correspondence Address: BROWDY AND NEIMARK, P.L.L.C.;624 NINTH STREET, NW, SUITE 300, WASHINGTON, DC, 20001-5303, US

(73) Assignee: HI-LEX CORPORATION, Takarazuka-shi (JP)

(21) Appl. No.: 12/045,109

(22) Filed: Mar. 10, 2008

(30) Foreign Application Priority Data
Mar. 9, 2007 (JP) JP2007-060120

(51) Int. Cl. E05F 11/54

(52) U.S. Cl. 49/352

(57) ABSTRACT

[Problem to be solved] To provide a cable guide which has a simple structure and can be easily assembled.

[Solution] The cable guide to change the direction of the inner cable which slide and drive the slide door of a vehicle comprises a box-like pulley case 11 whose upper surface is opened, a pulley 12 housed in the pulley case and pivoted rotatably, and a case cover 13 to cover the upper surface of the pulley case. The pulley case has a fixing portion 15 of the outer casing which slidably houses an inner cable. The fixing portion has grooves of roughly U-shaped cross section. The inner perimeter of the groove has a case protrusion 15a. A cover protrusion 13e is formed in the case cover so as to face the case protrusion.

### FIELD OF THE INVENTION

This invention relates to a cable guide to change the direction of an inner cable, more specifically, to a cable guide for a cable to slide a slide door of vehicles such as automobiles, small crafts.

### BACKGROUND ARTS

### Patent Document 1: Japanese Published Patent Application No. 2003-328639

### Patent Document 2: Japanese Published Patent Application No. 2002-194945

In FIG. 9, the case of Patent Document 1 is shown. The case 100 shown in FIG. 9 comprises two case members 101, 102. The lower case member 102 has a space 103 to house a pulley, and the upper portion of the space 103 is covered by the case member 101. In the side of the lower case member 102, a lead-in opening 102a is formed, where an outer tube 104 is latched. In the front end of the outer tube 104, a tube end 104a is provided, the annular groove portion of the tube end 104a is held by the lead-in opening 102a and the upper surface of the case member 101.

In FIG. 10, a cable holder of Patent Document 2 is shown. The cable holder 110 shown in FIG. 10 comprises a cable guide bracket 111 having a notched groove 111a, and a halved retainer 112 composed of a pair of hinged closable half-bodies 112a, 112a for tucking and fixing an outer cable (outer casing) 113. In the inner surface of the retainer 112, a convexoconcave portion 112c to fix the outer cable 113 is formed. In the free end of the hinged closable half bodies 112a, 112a; claws 112b, 112b for engaging with the notched grooves 111a are formed extending outwardly. To make the cable holder 110 support the outer cable 113, the outer cable 113 is tucked down into the hinged closable half bodies 112a, 112a. Then, while the both side of the hinged closable half bodies 112a, 112a are pinched by fingers to tuck the outer cable 113, the claws 112b, 112b to prevent the dropping are inserted into the notched groove 111a.

### DISCLOSURE OF THE INVENTION

### Problem to be Resolved by the Invention

In Patent Document 1, it is necessary to use the tube end 104a for coupling the outer tube 104 and the case 100, which makes the number of parts many. Moreover, before closing by the case member 101, since the groove portion formed in the tube end 104a is only inserted into the lead-in opening 102a of the case member 102, it ends up dropping out easily.

Further, in Patent Document 2, it is made so that the end of the outer cable 113 is built in the cable guide bracket 111 after being supported by the convexoconcave portion 112c. However, when it is built in the cable guide bracket 111, while the outer casing is held by fingers, the hinged closable half bodies 112a, 112a are subject to open on a sudden, and it leads the outer cables to falls down, which makes it difficult to build in.

Therefore, this invention provides a cable guide which has a simple structure and can be easily assembled.

### Means of Solving the Problems

The cable guide of this invention (claim 1) is a cable guide to change a direction of an inner cable, where the inner cable for sliding a slide door of a vehicle body. The cable guide comprises a pulley case of a box shape having an upper surface, the upper surface is opened, a pulley pivotably mounted and housed in the pulley case, and a case cover covering the upper surface of the pulley case. Further the pulley case includes a fixing portion having a groove of U-shaped cross section, where the groove for fixing a vicinal end of an outer casing, the outer casing slidably houses the inner cable. More, the cable guide further comprises a case protrusion formed on an inner perimeter of the groove for fixing the outer casing by biting the outer casing, and a cover protrusion formed on the case cover facing the case protrusion, the cover protrusion forces the outer casing to bite the case protrusion.

In such cable guide, it is preferable that the case protrusion is plural of U-shaped protruding lines arranged axially in parallel on the inner perimeter of the groove (claim 2).

### EFFECTS OF THE INVENTION

In the cable guide of this invention (claim 1), it is possible to make the vicinal end of the outer casing bite into the case protrusion in order to latch to the groove of the fixing portion. Therefore, it is possible to keep the end of the outer casing being temporarily tacked to the groove of the fixing portion while in assembling work, even a worker unlink his hands from the outer casing. Resulting the assembling work is easy. Moreover, after the case cover is arranged to cover the upper surface of the pulley case, the outer casing can be latched strongly because the cover protrusion depresses or forces the outer casing so as to bite into it.

In the cable guide where the case protrusion is plural of U-shaped protruding lines arranged axially in parallel on the inner perimeter of the groove, the latch of the outer casing becomes further secure. Because, the protruding lines bite in from the bottom and the both sides of the outer casing.

### BEST MODE FOR CARRYING OUT THE INVENTION

Next, the embodiments of the cable guide of this invention are described referencing the drawings

### BRIEF DESCRIPTION OF DRAWINGS

FIG. 1 is a breakdown perspective view showing an embodiment of the cable guide of this invention.

FIG. 2 is an outline partial perspective view showing a vehicle body for which the cable guide shown in FIG. 1 is used.

FIG. 3 is an outline cabling diagram showing a power slide door unit equipped with the cable guide of FIG. 1.

FIG. 4 is an A-A line cross section of FIG. 1.

FIG. 5 is a back view of the case cover of FIG. 1.

FIG. 6a is a front view of a grommet, FIG. 6b is a B-B line cross section of FIG. 6a.

FIG. 7 is a breakdown perspective view showing the other embodiment of the cable guide.

FIG. 8a is a front view of the grommet of FIG. 7, FIG. 8b is a C-C line cross section of FIG. 8a.

FIG. 9 is an outline drawing showing the prior art.

FIG. 10 is an outline drawing showing another prior art.

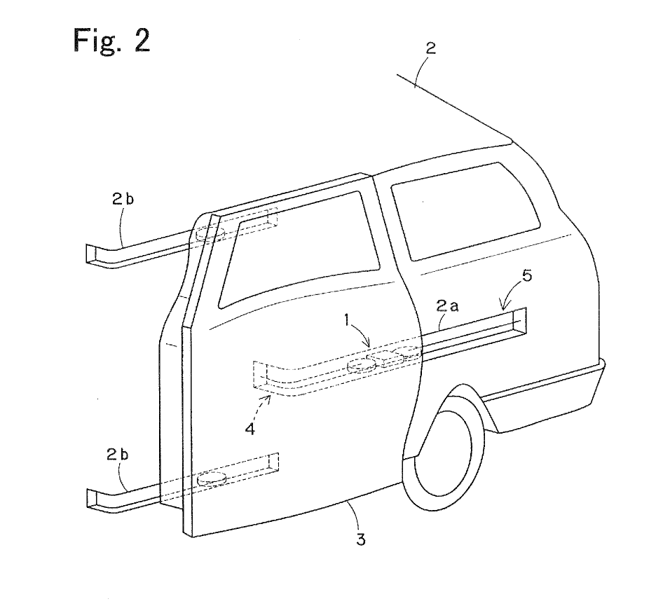

First, referencing FIG. 2, the power slide door unit for which the cable guide of this invention is used is described. The power slide door unit 1 shown in FIG. 2 is used for, for example, a one-box type vehicle body 2 etc. In the side of the vehicle body 2, a door 3 is provided. The door 3 slides along rails (center rail 2a, upper and lower rails 2b, 2c) provided in the center of the vehicle body, and the upper and lower ends of the vehicle body.

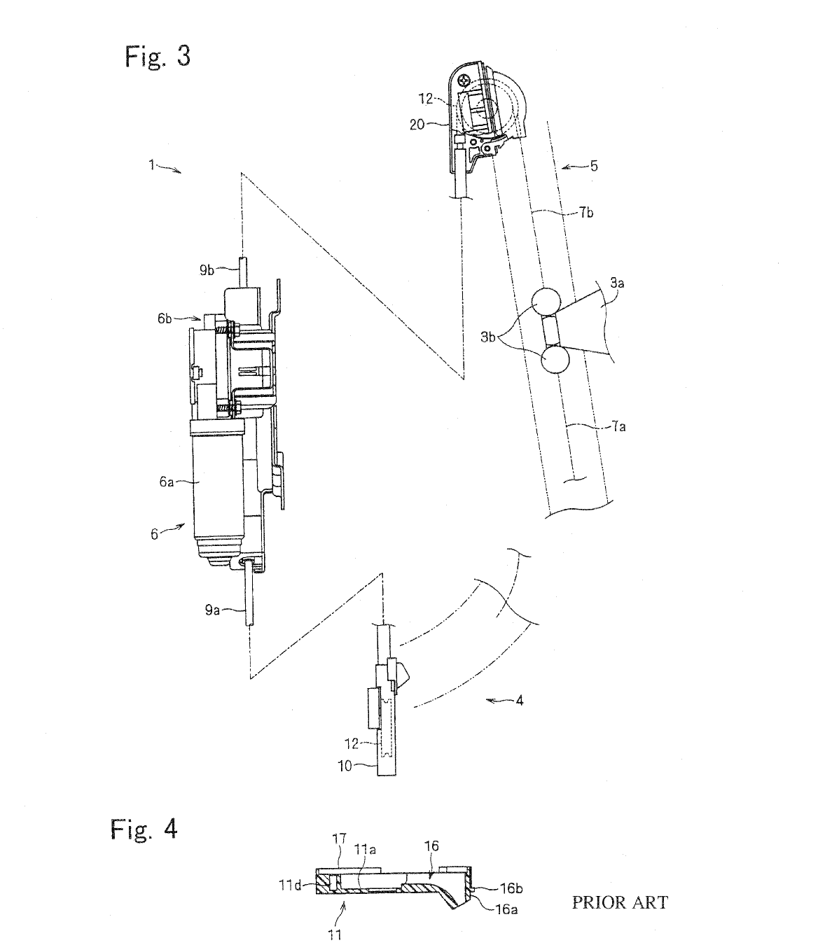

From hence, further detailed description is made referencing FIG. 3. The power slide door unit 1 shown in FIG. 3 is arranged in the vicinity of a center rail 2a located in the vicinity of center of the vehicle body 2. The vicinity of the front end 4 of the center rail 2a is bent toward the inside of the vehicle, and the vicinity of the rear end 5 is extended straight. An arm 3a to attach the door 3 is arranged slidably. In the arm 3a, a roller 3b etc. to roll in the center rail 2a is rotatably attached between the front and the rear end of the center rail 2a. In the arm 3a, the end of the inner cable 7a to move the door 3 forward and the end of the inner cable 7b to move the door 3 backward are attached. These inner cables 7a, 7b extend along the center rail 2a in the exterior of the vehicle body 2.

Moreover, a front cable guide 10 to change the direction of the inner cable is attached to the outer wall of the vehicle body 2 of the vicinity of the front end of the center rail 2a. In the front cable guide 10, a pulley 12 is pivoted so that its axis of rotation is directed to the right and left direction of the vehicle. And, the inner cable 7a for forward movement passes through a hole formed in the outer wall of the vehicle, enters into the interior of the vehicle body, after being turned around by the pulley 12, it is guided to the drive portion 6 by the front outer casing 9a. On the other hand, a rear cable guide 20 is attached in the vicinity of the rear end 5. In the rear cable guide 20, the pulley 12 is arranged and pivoted so that its axis of rotation is directed perpendicular to the right and left direction of the vehicle. And, the inner cable 7b for backward movement passes through a hole formed in the outer wall of the vehicle, enters into the interior of the vehicle, and after being turned around by the pulley 12, it is guided to the drive portion 6 by the front outer casing 9b.

The drive portion 6 has a drum (not shown in the figure) to reel off the other end of the inner cable 7a, 7b for forward movement and backward movement and to reciprocate cyclically the loop of the inner cable by winding back, a motor 6a to rotatably drive the drum, a clutch (not shown in the figure) to transmit the drive or to release the transmission, and a speed reducer 6b. In this embodiment, the drive portion 6 is arranged sideways. Those drive portion 6 and the outer casing 9a, 9b are housed in the panel of sidewall of an automobile.

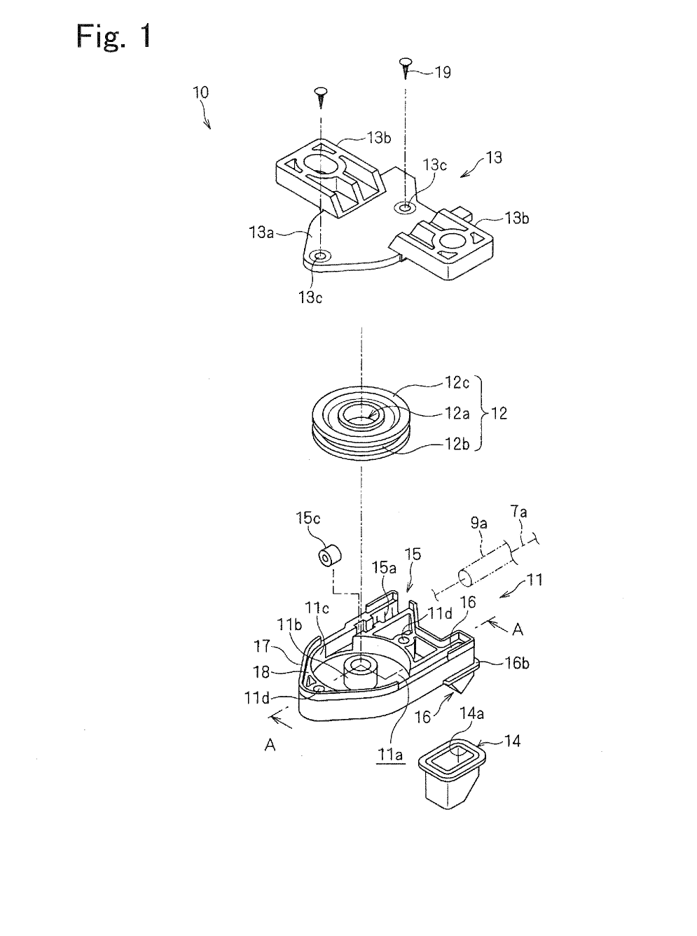

The front cable guide 10 shown in FIG. 1 comprises a pulley case 11, a pulley 12 pivoted in the pulley case, a case cover 13 to cover the upper surface of the pulley 12, and a front grommet 14 provided in the outer perimeter of the pulley case 11.

The pulley case 11 has a bottom 11a in its interior on which the lower surface of the pulley 12 slides, a cylindrical portion 11b protruding from about the vicinity of the center of the bottom 11a and pivots the pulley 12 rotatably, a standing wall 11c provided to stand upward from the side edge of the bottom 11a and arranged closely to the side peripheral surface of the pulley 12. In the outside of the standing wall 11c, tightening holes 11d, 11d are arranged.

Moreover, in the back of the standing wall 11c, a fixing portion 15 which leads the inner cable 7a for forward movement to the drive portion 6 side (see FIG. 3) penetrating the standing wall 11c, and fixes the tail end of the front outer casing 9a is formed at the same time. The fixing portion 15 has a groove whose cross section is roughly U-shaped, and a plurality of case protrusions (protruding lines 15a, 15a . . . ) extending in the hoop direction in the inner periphery surface of the groove is arranged axially in parallel. The length of the U-shaped groove is 10-15 mm, and is preferably 11-13 mm. The protruding line 15a formed in the inner periphery surface of the U-shaped groove is 0.2-0.5 mm in height, preferably 0.3-0.4 mm, and is 02.-0.5 mm in width, preferably 0.3-0.4 mm, and the number is 2-5, preferably 2-4. Further, between the fixing portion 15 and the standing wall 11c, a recessed portion to house a cylindrical elastic member 15c is provided. The elastic member 15c makes the inner cable 7a coming out from the front outer casing 9a pass through therein while elastically housing it. The elastic member 15c prevents the introduction of water or dust into the pulley case 11. As the material of the elastic member 15c, rubber, rubber-based resin or elastomer etc., preferably silicon rubber are used.

The shape of the protruding line 15 may be keen-edged chevron or a plurality of sharp protrusions directed to the front edge so as to bite into the front outer casing 9a deeply. Further, it is preferable that the protruding line 15 has a shape which completely surrounds the circumference of the outer casing 9 in order to increase the contact portion. Further, it may be provided with a barb such as being formed in a fish hook so as to constrain the direction of dropping out, and to prevent the once inserted front outer casing 9a from moving toward the direction to drop out. In addition, the protruding line 15 is preferable to have a shape being easy for molding, the protruded portion may be formed only in the protruding line 15 of the U-shaped bottom portion.

On the other hand, a guide path 16 penetrating the standing wall 11c is formed nearly in parallel with the fixing portion 15 under the fixing portion 15. The guide path 16 guides the inner cable 7a for forward movement turned around by the pulley 12 to the outside of the vehicle. The guide path 16 is equipped with a jut 16a (see FIG. 4) whose front edge extends toward the outside of the vehicle gradually bending backward (bottom 11a side). Moreover, a flange portion 16b extends around the periphery of the jut 16a (see FIG. 4).

The upper surface side including the standing wall 11c of the pulley case 11, the fixing portion 15, the guide path 16, and the tightening holes 11d is formed to be one plane. A periphery wall 17 is provided to stand upward along the outer periphery of the pulley case 11 from the plane 18 formed to be one plane. The extension of the periphery wall 17 makes the plane 18 of one plane be like shoulder. The pulley case 11 is preferable to be integrally formed of synthetic resin etc., and as the synthetic resin, polyester, polyamide (PA) or polyoxymethylene (POM), preferably polybutyleneterephthalate (PBT) are used.

The case cover 13 has a lid portion 13a, brackets 13b, 13b extending upward and downward from the lid portion which cover the upper surface of the bottom 11a, the fixing portion 15, and the guide path 16. And, in the lid portion 13a, holes 13c, 13c are formed at the position corresponding to the position of the tightening holes 11d of the pulley case. Since the lid portion 13a is fitted in along the inner periphery of the periphery wall 17, the assembling is easy. And, the rear surface of the case cover 13 just contacts the plane 18 of one plane of the pulley case 11, a tightening member 19 such as screw is tightened from the holes 13c of the upper surface of the lid portion 13a to the tightening holes 11d.

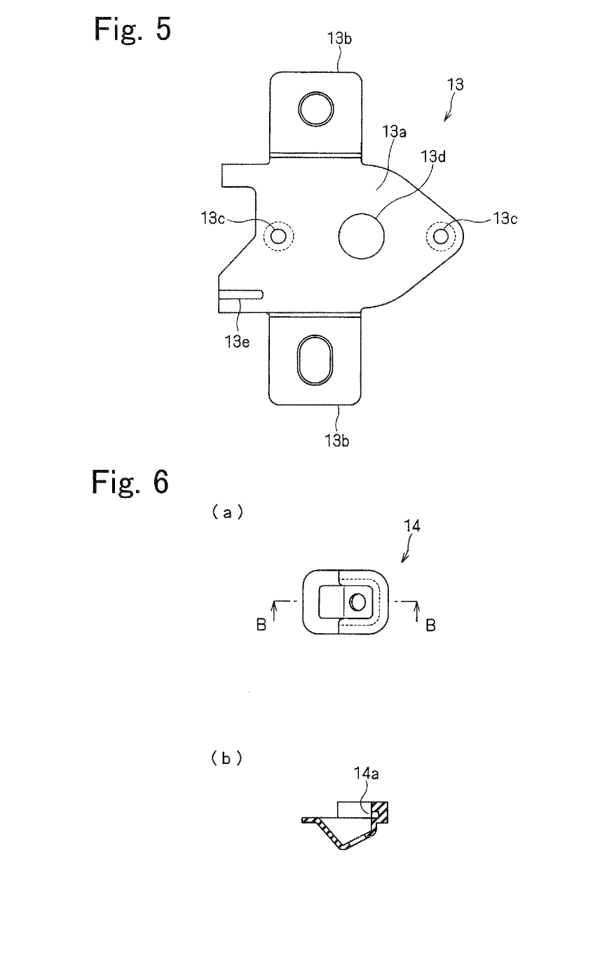

Moreover, in the center portion of the rear surface of the lid portion 13a shown in FIG. 5, a recessed concave portion 13d is formed, and the front edge of the cylindrical portion 11b of the pulley case 11 is arranged. Further in the portion corresponding to the fixing portion 15 of the pulley case 11 in the rear of the lid portion 13a, a cover protrusion (protrusion 13e) of slender rectangular shape which extends toward the axial direction of the outer casing 9a and protrudes toward the protruding lines 15a of the fixing portion 15 is formed. The protrusion 13e fixes the end of the outer casing 9a (see FIG. 1) for forward movement along with the protruding lines 15a. The protrusion 13e is 0.2-0.5 mm in height, preferably 0.3-0.4 mm, 8-15 mm in length, preferably 9-12 mm, 2-5 mm in width, preferably 2-3 mm. As the material of the case cover 13, polyester, polyamide (PA) or polyoxymethylene (POM), preferably polybutyleneterephthalate (PBT) are used.

Returning to FIG. 1, the pulley 12 comprises an opening 12a for being pivoted by the cylindrical portion 11b of the pulley case 11 formed in its center portion, and a guide groove 12b to guide the inner cable 7a for forward movement formed in its vicinity of the center of the periphery side. The perimeter of the opening portion 12a pivoted by the cylindrical portion 11b of the center of the pulley 12 presents a raised cylindrical shape, the cylindrical upper and lower end surfaces are tucked down by the bottom 11a of the pulley case 11 and the rear of the lid portion 13a of the case cover, and is slidable. The shoulder 12c formed in the further outside of the radius direction from the raised portion of the opening 12a of the pulley 12 is arranged with a slight clearance to the bottom 11a of the pulley case 11 and the rear of the lid portion 13a of the case cover 13. Thereby, the stable rotation of the pulley 12 is kept. Between the outer perimeter of the pulley 12 and the standing wall 11c of the pulley case 11, it prevents the dropping out of the inner cable 7a for forward movement from the guide groove 12b since a clearance smaller than the diameter of the inner cable 7a for forward movement is formed. As the material of the pulley 12, polyoxymethylene (POM), polyester or polyamide (PA), preferably polyoxymethylene (POM) are used.

The front grommet 14 shown in FIG. 6 is attached by engaging an engaging groove 14a with the flange portion 16b of the jut 16a of the pulley case 11 (see FIG. 1). And, it is arranged so as to cover the outer perimeter of the jut 16a to prevent water and dust to infiltrate into the inside of the pulley case 11 from the outside of the vehicle. As the material for the grommet 14, rubber, rubber-based resin, preferably chloroprene rubber (CR) are used.

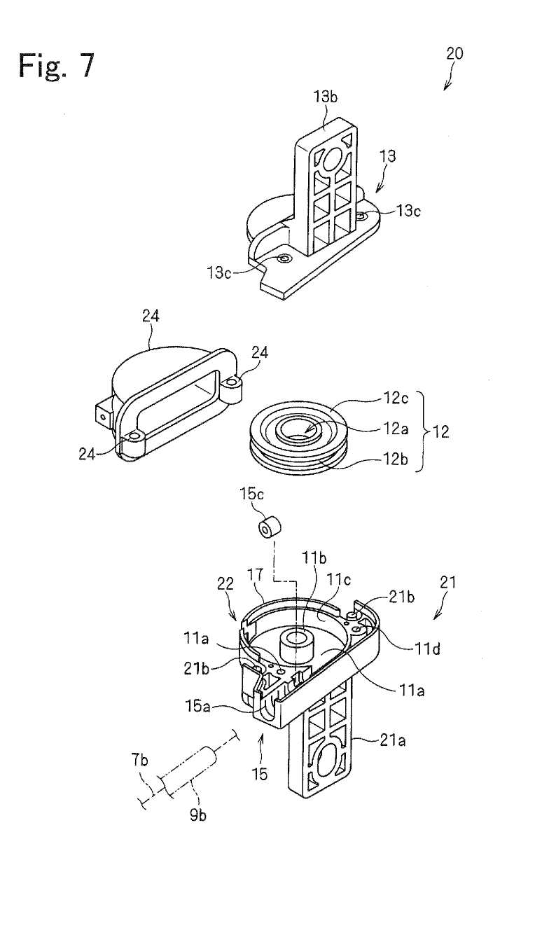

In FIG. 7, a rear cable guide 20 is shown. Since this has the similar portion to the front cable guide 10, the description of the same portion given the same reference numeral is omitted. The rear cable guide 20 comprises a pulley case 21, a pulley 12 pivoted in the pulley case, a case cover 23 covering the upper surface of the pulley 12, a rear grommet 24 provided in the outer perimeter of the pulley case 21.

The pulley case 21 has a bottom 11a in its interior on which the lower surface of the pulley 12 slides, a cylindrical portion 11b which protrudes from about the vicinity of the center of the bottom 11a and pivots the pulley 12 rotatably, and a standing wall 11c provided to stand upward form the vicinity of the side edge of the bottom 11a and arranged closely to the side peripheral surface of the pulley 12. In the outside of the standing wall 11c, tightening holes 11d, 11d are arranged. In the backside of the standing wall 11c, a fixing portion 15 which leads the inner cable 7b for backward movement to the drive portion 6 side (see FIG. 3) penetrating the standing wall 11c, and fixes the tail end of the rear outer casing 9b at the same time is formed. The fixing portion 15 has a groove whose cross section is roughly U-shaped, and has a plurality of case protrusions (protruding lines 15a, 15a . . . ) extending in the hoop direction in the inner periphery surface of the groove.

In the pulley case 21, a guide hole 22 communicating with the outside of the vehicle 2 is formed penetrating the standing wall 11c. And, the inner cable 7b introduced from the fixing portion 15 is extended outward from the guide hole 22 formed in the standing wall 11c after being turned around by the pulley 12. In the rear of the pulley case 21, a bracket 21a which is an attaching portion to the vehicle is formed. Moreover, also to the outside surface of the case cover 23, the brackets 13b extend outward. In addition, a pair of support rods 21b, 21b is formed, in the outside of the standing wall 11c of the pulley case 21. When the case cover 23 is fixed, the inside of the case cover 23 is arranged just on the upper surface of the support rods 21b.

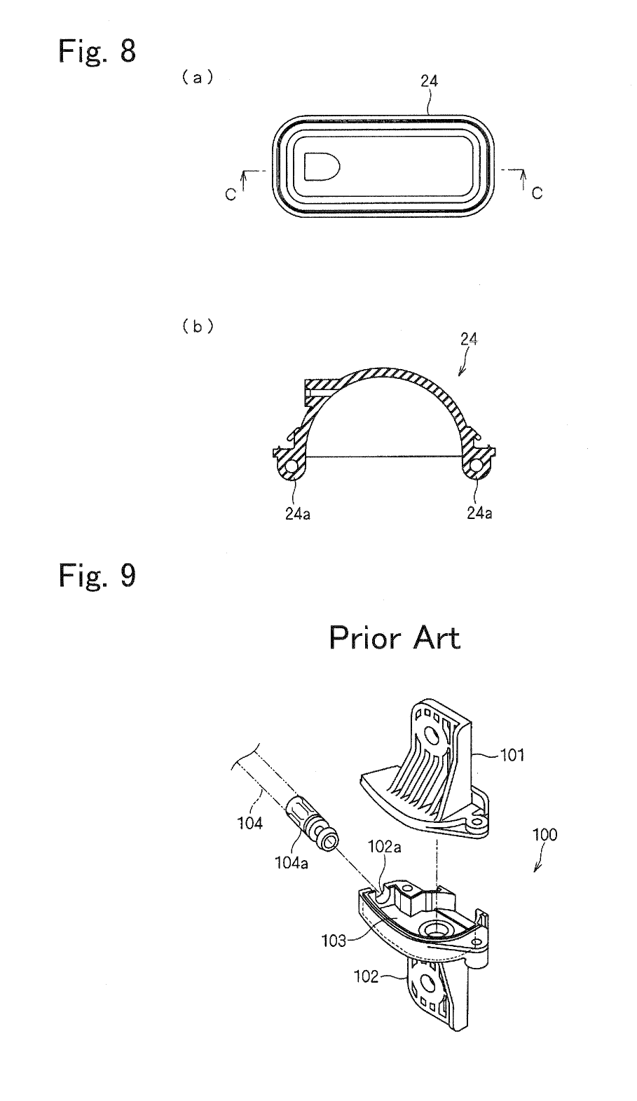

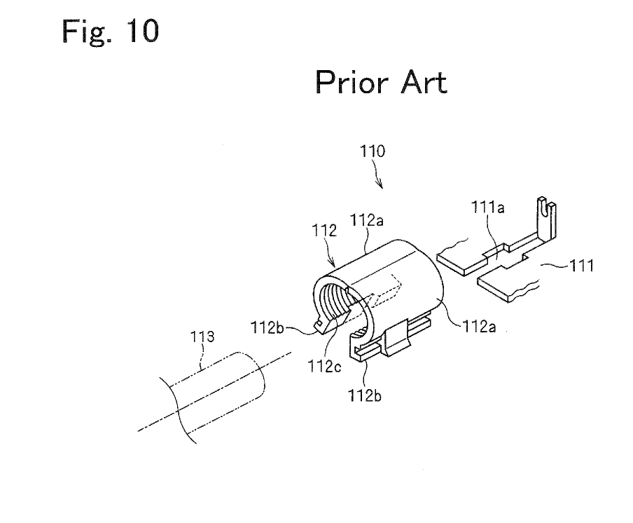

The rear grommet 24 shown in FIG. 7 and FIG. 8 is equipped with fitting pieces 24a, 24a which can be fitted in the support rods 21b, 21b of the pulley case 21. It is arranged so as to cover nearly whole of the portion protruding outside of the vehicle of the pulley case 21. It prevents the infiltration of water and dust into the inside of the pulley case from the outside of the vehicle. In addition, the attachment of the rear grommet 24 to the pulley case 21 may the attachment of the flange portion 16b and the engaging groove 14a such as the front grommet 14 and the pulley case 11.

By pushing in the front end of the outer casing 9a, 9b toward the protruding lines 15a, 15a . . . , the arranging of the pulley case 12 and the case covers 13, 23 is easy, since the temporal tacking of the outer casing 9a, 9b is possible.

1. A cable guide to change a direction of an inner cable, the inner cable for sliding a slide door of a vehicle body, comprising;
a pulley case of a box shape having an upper surface, the upper surface is opened;
a pulley pivotably mounted and housed in the pulley case; and
a case cover covering the upper surface of the pulley case;
wherein the pulley case includes a fixing portion having a groove of U-shaped cross section, the groove for fixing a vicinal end of an outer casing, the outer casing slidably houses the inner cable,
wherein a case protrusion is formed on an inner perimeter of the groove for fixing the outer casing by biting the outer casing,
wherein a cover protrusion is formed on the case cover facing the case protrusion, the cover protrusion forces the outer casing to bite the case protrusion.

2. A cable guide according to claim 1,
wherein the case protrusion is plural of U-shaped protruding lines arranged axially in parallel on the inner perimeter of the groove.
